(19) United States
(12) Patent Application Publication
(10) Pub. No.: US 2010/0088415 A1
(43) Pub. Date: Apr. 8, 2010

(54) METHOD AND APPARATUS FOR LOCATING FACILITIES

(76) Inventors: AARON ARCHER, Hoboken, NJ (US); Shankar Krishnan, Chatham, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/246,973

(22) Filed: Oct. 7, 2008

(51) Int. Cl. G06F 15/16

(52) U.S. Cl. 709/227

(57) ABSTRACT

A method and apparatus for providing facility location plans for a network are disclosed. For example, the method identifies a facility and a number of nearest active clients associated with a minimized cost per unit demand of connecting these clients to this facility. The method then connects the number of nearest active clients to the facility associated with the minimized cost per unit demand. In one embodiment, the method iterates this process with the remaining clients until all demands have been assigned to facilities.

The present invention relates generally to communication and transportation networks and, more particularly, to a method for locating facilities in a network, e.g., Internet Protocol (IP) network, wireless network, distribution network for physical goods, and the like.

### BACKGROUND OF THE INVENTION

Today's communications networks are vast and complex. Service providers invest a great deal of resources to plan their network and capital expenditures. For example, service providers need to determine where to place their network resources, e.g., servers, routers and the like. The service provider may plan facility locations with the goal of providing services to customers with an efficient use of the network resources.

A customer may be able to access a set of potential facilities that can provide the service. One method for modeling the service cost of a facility location solution is to assign a fixed cost for using the facility at all (i.e., “opening” it), and serving an unlimited amount of demand. Another method is to assume a facility cost that increases monotonically with the demand served. In both cases, there is also a transportation cost associated with connecting each demand to a facility, in addition to the service cost. However, both the connection cost for a customer to reach a facility and the cost of providing the service over the facility are different for different facilities.

### SUMMARY OF THE INVENTION

In one embodiment, the present invention discloses a method and apparatus for providing facility location for a network. For example, the method identifies a facility and a number of nearest active clients associated with a minimized cost per unit demand of connecting the number of nearest active clients to the facility. The method then connects the number of nearest active clients to the facility associated with the minimized cost per unit demand.

In one embodiment, the method iterates this process with the remaining clients until all demands have been assigned to facilities.

### BRIEF DESCRIPTION OF THE DRAWINGS

The teaching of the present invention can be readily understood by considering the following detailed description in conjunction with the accompanying drawings, in which:

FIG. 1 is a block diagram depicting an exemplary packet network related to the current invention;

FIG. 2 illustrates an exemplary network for providing facility location;

FIG. 3 illustrates a flowchart of a method for providing facility location for a network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a facility location for a network. Although the present invention is discussed below in the context of a packet network, the present invention is not so limited. Namely, the present invention can be applied to other networks, such as Internet Protocol (IP) networks, switched networks, wireless networks, distribution networks for physical goods, and the like.

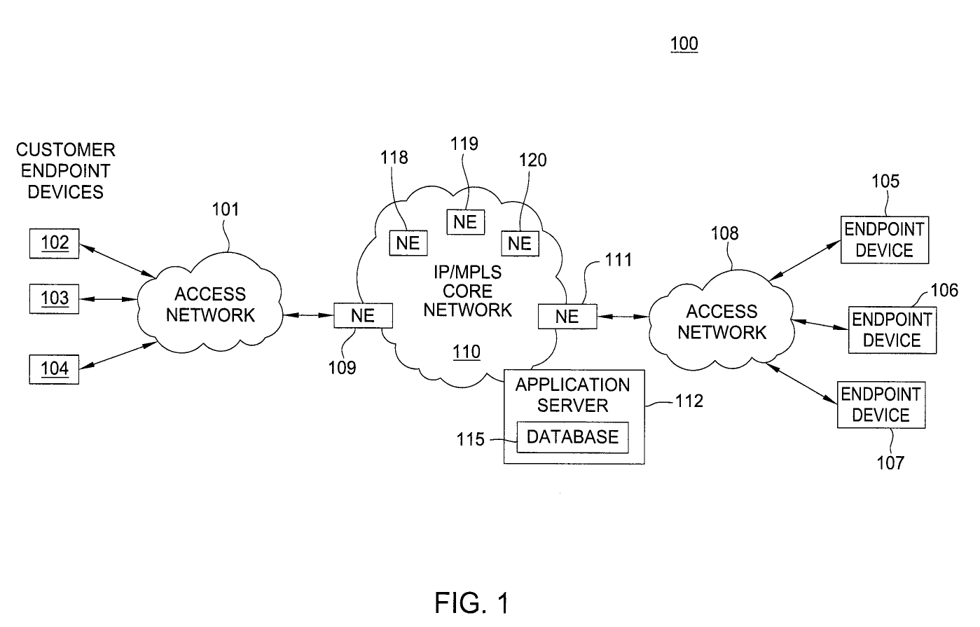

FIG. 1 is a block diagram depicting an illustrative packet network 100 related to the current invention. Exemplary packet networks may include Internet protocol (IP) networks, Ethernet networks, and the like. An IP network is broadly defined as a network that uses Internet Protocol such as IPv4, IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements, one application server, and so on are depicted in FIG. 1, the communication system 100 may be expanded by including additional endpoint devices, access networks, network elements, application servers, and the like, without altering the present invention. The above IP network is described to provide an illustrative environment in which packets for voice and data services are transmitted on networks.

In one embodiment, the current invention discloses a method and apparatus for providing one or more facility locations in networks such as Internet Protocol (IP) networks. More specifically, the method provides a facility location plan in a network by selecting a set of facilities in the network and an optimal assignment of a given set of clients in the network to this set of facilities that minimizes the sum of two types of costs: 1) a connection cost between each client and its assigned facility, and 2) a facility cost for each open facility.

In one embodiment, the connection cost for a demand equals to the distance between that demand and the facility that serves it. In a communication network, this connection cost could represent air miles, fiber miles, or routing latency; in a physical distribution network, it could represent the cost of transporting goods. In one embodiment, the facility cost may comprise one or more facility cost functions, e.g., a function of the amount of demand served by that facility and so on. The form of the facility cost functions is flexible, other than that the facility cost functions are non-negative everywhere and evaluate to zero when the demand served is zero. The problem of finding the facility locations that minimize the sum of the two types of cost may also be referred as the Facility Location with Arbitrary Facility Costs (FLAFC) problem.

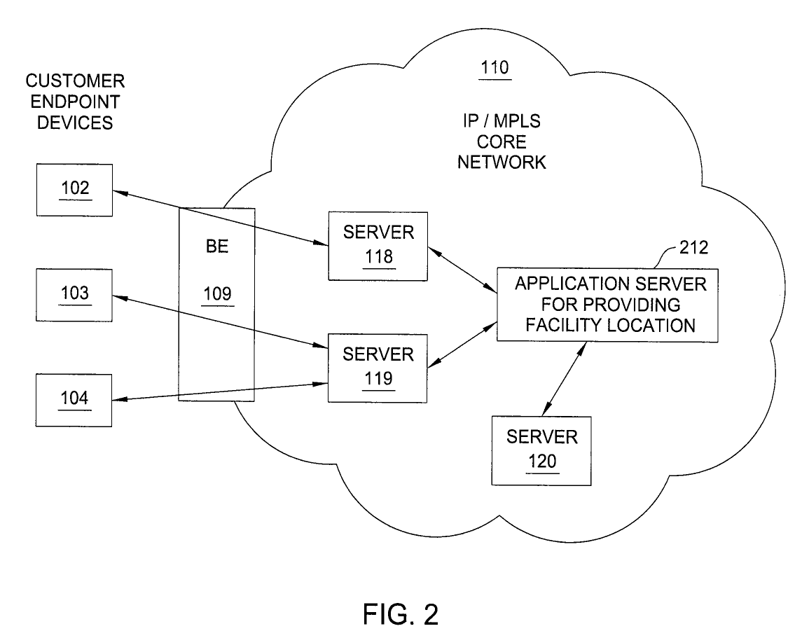

FIG. 2 illustrates an exemplary network 200 for providing facility location. For example, customer endpoint devices 102-104 access services from the IP/MPLS network 110 via a border element 109. The IP/MPLS core network 110 may contain servers 118, 119 and 120 for providing services to the customers. A customer may receive service from any one of the servers 118, 119 or 120. The IP/MPLS core network 110 also contains an application server 212 for providing facility location. The application server 212 assigns each of the clients (e.g., customer endpoint devices) 102, 103 and 104 to be serviced by one of the servers (or more broadly facilities having one or more network resources such as a server, a switch, a router and the like) 118, 119 or 120. In one embodiment, the application server 212 selects the particular server (or facility) a customer endpoint device should use by using the current invention to minimize the sum of all connection costs and facility costs as described below.

In order to clearly illustrate the teachings of the current invention, a mathematical model will first be provided below.

Let,
[symbol] represent a set of facilities,
n_{f}=|F| represent the number of facilities in the set [symbol] ,
C represent a set of clients (or demand points), and
n_{c}=|C| represent the number of clients in the set C.

For each facility iε [symbol] and each demand point jεC, there is a connection cost dᵢⱼ, which is the cost of serving one unit of demand from client j by the facility i. For each facility iε [symbol] , there is a facility cost function fᵢ:{0, 1, 2, . . . n_{c}}->R⁺. Each facility cost function is non-negative and fᵢ(0)=0.

In one embodiment, the method determines an assignment φ:C→ [symbol] , wherein each client j is served by a facility φ(j), and Dᵢ(φ)=|{j:φ(j)=i}| is the total demand served by a facility i. If a facility serves a positive amount of demand then it is open. Otherwise, it is a closed facility. The assignment φ is determined with a goal of minimizing the total of the connection and facility costs. Specifically, our goal is to select φ to minimize Σ_{jεC}^{d}_{φ(j)j}+Σ_{iεF}fᵢ[Dᵢ(φ)].

In one embodiment, the method provides an algorithm for finding φ. The algorithm first maintains a set of active clients A. The term “active client” refers to an as-yet unassigned client. Initially, the set of active clients is set to be the same as the entire set of clients, and the demand served by a facility i is set to zero. That is, the algorithm performs initializations as follows:

A←C, and

Dᵢ=0 for each iε [symbol] .

For each iε [symbol] and each kε{1, . . . , |A|}, the method then computes the intermediate quantities:
Nᵢ(k)—a subset of A, representing the k active clients that are closest to facility i
eᵢ(k)—which represents the incremental facility cost incurred if k more clients were to be connected to facility i,
gᵢ(k)—which represents the sum of the distances from facility i to each of the k active clients in Nᵢ(k), and
αᵢ(k)—which represents the cost per unit demand of connecting to facility i all of the k active clients in Nᵢ(k) and serving them.

Specifically,
Nᵢ(k): List the clients j in A in order of increasing value of dᵢⱼ, with ties broken arbitrarily. Let Nᵢ(k) be the first k clients in this sorted list.

eᵢ(k)←fᵢ(Dᵢ+k)−fᵢ(Dᵢ),

gᵢ(k)←Σ_{jεN}_{ᵢ}_{[k]}dᵢⱼ, and

αᵢ(k)←(eᵢ(k)+gᵢ(k))/k.

In one embodiment, the method then identifies the values of i and k that minimize αᵢ(k). That is, [ī, k̅]←arg min_{[i,k]}αᵢ(k), wherein [ī, k̅] minimize the incremental cost per unit demand of connecting to facility i all of the k active clients in Nᵢ(k) and serving them.

The method then connects the k active clients that are nearest to facility ī to the facility ī. Mathematically, for each jεN_{ī}[ k̅], the method connects client j to facility i. That is, the method sets φ(j)←ī.

The method then updates the amount of demand served by the facility ī. Mathematically, the method sets D_{ī}←D_{ī}+ k̅. Once the amount of demand served by the facility ī is updated, the method deactivates the clients that have been connected. That means, set A is updated to remove from the active set the clients that have been connected. Mathematically, the clients in N_{ī}[ k̅] are deactivated by performing

A←A\N_{ī}[ k̅].

The method then determines if the set A is non-empty. If the set A is non-empty, the method then repeats the process by re-computing the intermediate quantities, identifying the most cost-effective connection of clients, and so on, until all clients are inactive.

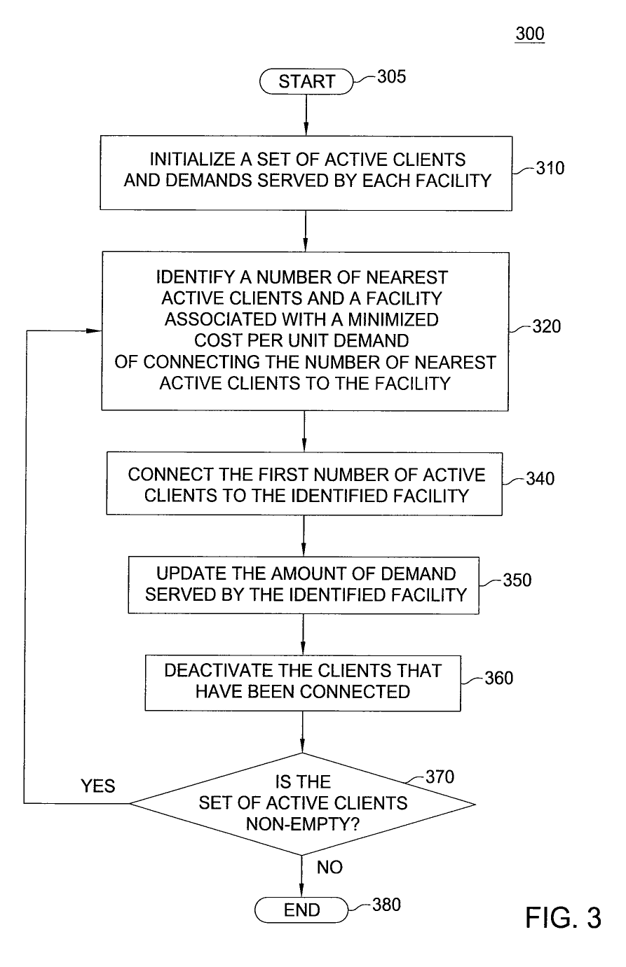

FIG. 3 illustrates an exemplary flowchart of a method 300 for providing facility location. For example, one or more steps of method 300 can be implemented by the application server 212. Method 300 starts in step 305 and proceeds to step 310.

In step 310, method 300 initializes a set of active clients and demand served by each facility. For example, the set of active clients may be set to be the same as the set of clients, and the demand served by a facility i may be set to zero.

In step 320, method 300 identifies a number of nearest active clients and a facility associated with a minimized cost per unit demand of connecting the number of nearest active clients to the facility. For example, the method identifies the specific values of i and k that minimize αᵢ(k). Call these ī the k̅.

In step 340, method 300 connects the first number of active clients to the identified facility. For example, the method connects to the facility ī the k̅ active clients that are nearest to the identified facility ī.

In step 350, method 300 updates the amount of demand served by the identified facility. For example, the method may add the newly added number of connections to the previous total number of client connections that were being served by the identified facility. Namely, the method may set D_{ī}←D_{ī}+ k̅.

In step 360, method 300 deactivates the clients that have been connected. That means, the set of active clients is updated to remove the clients that have been connected. For example, clients in N_{ī}[ k̅] may be deactivated by performing

A←A\N_{ī}[ k̅].

In step 370, method 300 determines if the set of active clients A is non-empty. If the set is non-empty, the method proceeds to step 320. If the set is empty, the method proceeds to step 380 to end processing the current assignment of clients to facilities.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

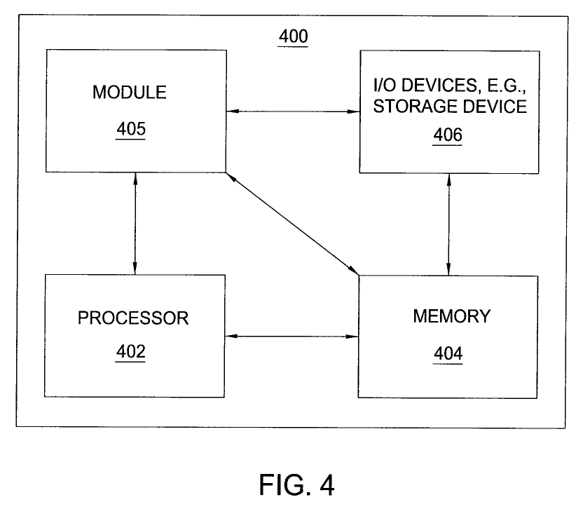

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing a facility location for a network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for providing a facility location for a network can be loaded into memory 404 and executed by processor 402 to implement the functions as discussed above. As such, the present method 405 for providing a facility location for a network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a facility location plan for a network, comprising:
identifying a facility and a number of nearest active clients associated with a minimized cost per unit demand of connecting the number of nearest active clients to the facility; and
connecting said number of nearest active clients to said facility associated with said minimized cost per unit demand.

2. The method of claim 1, further comprising:
initializing a set of active clients and a demand served by the facility.

3. The method of claim 2, wherein said initializing is performed by setting said set of active clients to be the same as a set of clients, and setting the demand served by the facility to zero.

4. The method of claim 1, further comprising:
updating an amount of demand served by said facility associated with said minimized cost per unit demand; and
deactivating said number of nearest active clients that have been connected.

5. The method of claim 1, further comprising:
determining if a set of active clients is non-empty; and
repeating said identifying step and said connecting step until said set of active clients is empty.

6. The method of claim 1, wherein said cost per unit demand of connecting said number of nearest active clients to the facility is based on one or more of: a sum of distances of said number of nearest active clients to said facility, or incremental facility costs incurred if said number of nearest active clients are connected to said facility.

7. The method of claim 1, wherein said facility has a cost that is non-negative everywhere and zero when the demand served by said facility is zero.

8. A computer-readable medium having stored thereon a plurality of instructions, the plurality of instructions including instructions which, when executed by a processor, cause the processor to perform the steps of a method for providing a facility location plan for a network, comprising:
identifying a number of nearest active clients and a facility associated with a minimized cost per unit demand of connecting the number of nearest active clients to the facility; and
connecting said number of nearest active clients to said facility associated with said minimized cost per unit demand.

9. The computer-readable medium of claim 8, further comprising:
initializing a set of active clients and a demand served by the facility.

10. The computer-readable medium of claim 9, wherein said initializing is performed by setting said set of active clients to be the same as a set of clients, and setting the demand served by the facility to zero.

11. The computer-readable medium of claim 8, further comprising:
updating an amount of demand served by said facility associated with said minimized cost per unit demand; and
deactivating said number of nearest active clients that have been connected.

12. The computer-readable medium of claim 8, further comprising:
determining if a set of active clients is non-empty; and
repeating said identifying step and said connecting step until said set of active clients is empty.

13. The computer-readable medium of claim 8, wherein said cost per unit demand of connecting said number of nearest active clients to the facility is based on one or more of: a sum of distances of said number of nearest active clients to said facility, or incremental facility costs incurred if said number of nearest active clients are connected to said facility.

14. The computer-readable medium of claim 8, wherein said facility has a cost that is non-negative everywhere and zero when the demand served by said facility is zero.

15. An apparatus for providing a facility location plan for a network, comprising:
means for identifying a number of nearest active clients and a facility associated with a minimized cost per unit demand of connecting the number of nearest active clients to the facility; and
means for connecting said number of nearest active clients to said facility associated with said minimized cost per unit demand.

16. The apparatus of claim 15, further comprising:
means for initializing a set of active clients and a demand served by the facility.

17. The apparatus of claim 16, wherein said initializing is performed by setting said set of active clients to be the same as a set of clients, and setting the demand served by the facility to zero.

18. The apparatus of claim 15, further comprising:
means for updating an amount of demand served by said facility associated with said minimized cost per unit demand; and
means for deactivating said number of nearest active clients that have been connected.

19. The apparatus of claim 15, further comprising:
means for determining if a set of active clients is non-empty; and
means for repeating said identifying step and said connecting step until said set of active clients is empty.

20. The apparatus of claim 15, wherein said cost per unit demand of connecting said number of nearest active clients to the facility is based on one or more of: a sum of distances of said number of nearest active clients to said facility, or incremental facility costs incurred if said number of nearest active clients are connected to said facility.
